(19) United States
(12) Patent Application Publication
(10) Pub. No.: US 2006/0045304 A1
(43) Pub. Date: Mar. 2, 2006

(54) Smart earphone systems devices and methods

(75) Inventors: Mike Lee, San Jose, CA (US); Don Brunnett, Pleasanton, CA (US); Tim Glassburn, Milpitas, CA (US)

Correspondence Address: FOLEY & LARDNER, 2029 CENTURY PARK EAST, SUITE 3500, LOS ANGELES, CA, 90067, US

(73) Assignee: Maxtor Corporation

(21) Appl. No.: 11/026,214

(22) Filed: Dec. 30, 2004

Related U.S. Application Data
(60) Provisional application No. 60/606,868, filed on Sep. 2, 2004.

(51) Int. Cl. H04R 25/00

(52) U.S. Cl. 381/384

(57) ABSTRACT

A smart earphone device for use with a host device includes an earphone and a detection element. The earphone is capable of converting sound signals provided by the host device into audible sound. The detection element provides detection output from which it can be determined whether or not the earphone is in a listening position. The detection output can be used to cause the host device to control or perform an operation.

### CROSS-REFERENCE TO RELATED PATENT APPLICATIONS

Embodiments of the present invention relate to U.S. Provisional Application Ser. No. 60/606,868, filed Sep. 2, 2004, entitled “Smart Earbuds”, the contents of which are incorporated by reference herein and which is a basis for a claim of priority.

### BACKGROUND OF THE INVENTION

1. Field of the Invention

Embodiments of the present invention relate generally to systems, devices, and methods employing earphones for converting audio signals provided by a host device into audible sound and, in specific embodiments, to a smart earphone device comprising an earphone and a detection element, and that can cause a host device to control a function based on whether or not the earphone is in a listening position.

2. Related Art

In recent years, there has been an explosion in the number of audio providing devices used for work and entertainment. Such audio providing devices or host devices include, but are not limited to, personal computers, cell phones, DVD players, MP3 players, radios, and cassette players. In order to listen to the audio signals provided by such host devices, users often employ earphones, including earbuds and headphones, to convert the provided audio signals into audio sound and to keep the audio sound private.

When a user desires to listen to the audio sound, the user must position an earphone in a listening position, such as by fitting the earphone into an ear or holding the earphone next to an ear, and the user must also issue a command to the host device to cause the host device to provide the audio signals. For example, if a user desires to listen to music from an MP3 player, the user must first insert an earphone into an ear and then must additionally locate and press the play button on the MP3 player. Even though the user may be prepared to receive the audio signals when the earphone is in a listening position, a separate command must still be issued to the host device before the audio signals are provided. Thus, there is an inconvenience to the user in that the host device does not provide audio signals automatically when the earphone is in a listening position, but the user must additionally issue a command to the host device.

A similar problem exists when the user desires to stop listening to the audio signals provided by the host device. To stop listening to the audio signals provided by the host device, the user typically removes the earphone from the listening position and then also issues a command to the host device to cause the host device to stop providing the audio signals. For example, to stop listening to music provided by an MP3 player, a user typically removes an earphone from an ear and then presses a stop button on the MP3 player. Thus, there is an inconvenience to the user in that the host device does not stop providing the audio signals automatically when the earphone is removed from a listening position, but the user must also issue an additional command to the host device. The need to locate and operate correct buttons or other controllers can be especially inconvenient in contexts when the user is driving, operating machinery, or engaged in other activities in which the user's constant attention is desired.

Furthermore, there may be additional problems caused if the user forgets to issue the command to the host device once the earphone has been removed from the listening position. Specifically, if the user forgets to stop the host device from providing audio signals once the earphone has been removed from the listening position, the host device will continue to provide the audio signals. If the host device continues to provide audio signals when the user is not listening, then there is a waste of battery power because power is required to provide the audio signals even when no one is listening. Also, the user may unintentionally miss a part of the entertainment or have to later rewind the content if the user forgets to stop the host device when the earphone has been removed from the listening position.

The problem of wasting battery power can be illustrated by the example of a hearing aid being removed by a user at bedtime. When going to bed, the user may be sleepy and forget to turn off the hearing aid after removing the hearing aid from an ear. Thus, the hearing aid would remain on while the user sleeps and, thus, the battery life would be diminished.

The problem of missing part of the entertainment can be illustrated by the example of a user listening to a movie while waiting to board an airplane for a flight. If an announcement comes over a loudspeaker in the airport, the user may remove an earphone to listen to the announcement, but forget to press pause on the video player. Once the announcement is completed, the user may desire to resume watching the movie, but will have missed the part that was playing during the announcement. The user could then continue watching and miss that part of the movie or, if the user desired to see the entire movie, rewind to the beginning of the missed portion. Thus, the experience of the entertainment user would not be smooth. Many other similar types of examples of forgetting to stop the host device are not difficult to imagine in an interruption prone world.

Even worse than wasting battery life and missing entertainment, the need to issue an additional command to a host device after removing an earphone from a listening position may create a safety hazard. For example, if a user is listening to a phone call while driving and the user desires to end the call, it is not enough to simply remove an earphone, but the user must typically also press a button on the phone or earphone cable to end the call. In order to find the button, users may have to divert their attention from the road to look at the phone, thus creating a safety hazard.

In light of the above mentioned problems, there is a need to automatically and transparently control a host device based on whether or not an earphone is in a listening position.

### SUMMARY OF THE DISCLOSURE

Embodiments of the present invention relate to a smart earphone device for automatically and transparently controlling a host device based on whether or not an earphone is in a listening position. Such a smart earphone device may increase user convenience, smooth out the experience of an entertainment user, and help to conserve battery power.

A smart earphone device according to a general embodiment of the present invention includes an earphone and a detection element. The earphone is capable of converting sound signals provided by a host device into audible sound. The detection element provides detection output from which it can be determined whether or not the earphone is in a listening position. The detection output can be used to cause the host device to control or perform an operation.

In various embodiments, the earphone of the smart earphone device includes an earphone body, and the detection element is disposed on the earphone body or is embedded within the earphone body. Types of earphones include, but are not limited to, earbuds, earpieces, headphones, and the like. In various embodiments, the earphone comprises a receiver located in a handset of a telephone or cellular phone. Some types of earphones are placed in a listening position by being fit into an ear of a user. Other types of earphones are placed in a listening position by being held next to an ear of a user.

In various embodiments, the detection element includes, but is not limited to, a sensor, such as a pressure sensor, a temperature sensor, a light sensor, an audio sensor, and the like. In various other embodiments the detection element includes a switch, a capacitive touch plate, a circuit with conductive contact points, or the like. The detection element provides detection output that can be used to cause a host device to perform one or more operations.

Different types of host devices may perform different types of operations or functions. Examples of operations or functions that could be performed by a host device include, but are not limited to, turning on and turning off. If the host device is of a type that provides sound signals from stored sound recordings, the host device may perform the operations of play, pause, stop, rewind, fast forward, volume up, volume down, mute, and the like. If the host device is a type of portable telephone, the host device may perform the operations of dial, hang up, provide dial tone, and the like.

Further embodiments of the smart earphone device include two or more earphones and two or more detection elements. By adding a second earphone and a second detection element, there is an opportunity to provide added functionality. For example, different operations could be performed depending on whether (a) both earphones are in listening positions; (b) one earphone is in a listening position and the other earphone is not in a listening position; or (c) both earphones are not in listening positions.

Therefore, embodiments of the present invention allow for a smart earphone device to cause a host device to perform a function or operation based on whether or not an earphone has been placed in a listening position or has been removed from a listening position. Various other embodiments relate to systems that include a host device along with a smart earphone device and to methods of making and using a smart earphone device.

### BRIEF DESCRIPTION OF THE DRAWINGS

FIG. 1 is a block diagram of a system having a smart earphone device in communication with a host device in accordance with an embodiment of the invention.

FIG. 2 is an illustration of a smart earphone device of an embodiment being used by a user.

FIG. 3A is a block diagram of an example of a detection element that comprises conductive contact points.

FIG. 3B is a side view of a smart earphone device showing an example of conductive contact points disposed on an earphone body.

FIG. 4 is a block diagram of an example of a detection element that comprises a capacitive touch plate.

FIG. 5 is a block diagram of an example of a detection element that comprises a temperature sensor.

FIG. 6 is a flowchart representing an example process carried out by the smart earphone device and host device of FIG. 1, according to an embodiment of the invention.

FIG. 7 is a flowchart representing another example process carried out by the smart earphone device and host device of FIG. 1, according to another embodiment of the invention.

FIG. 8 is a block diagram of a smart earphone device in communication with a host device in accordance with an embodiment of the invention.

FIG. 9 is a flowchart representing an example process carried out by the smart earphone device and host device of FIG. 8, according to an embodiment of the invention.

### DETAILED DESCRIPTION OF PREFERRED EMBODIMENTS

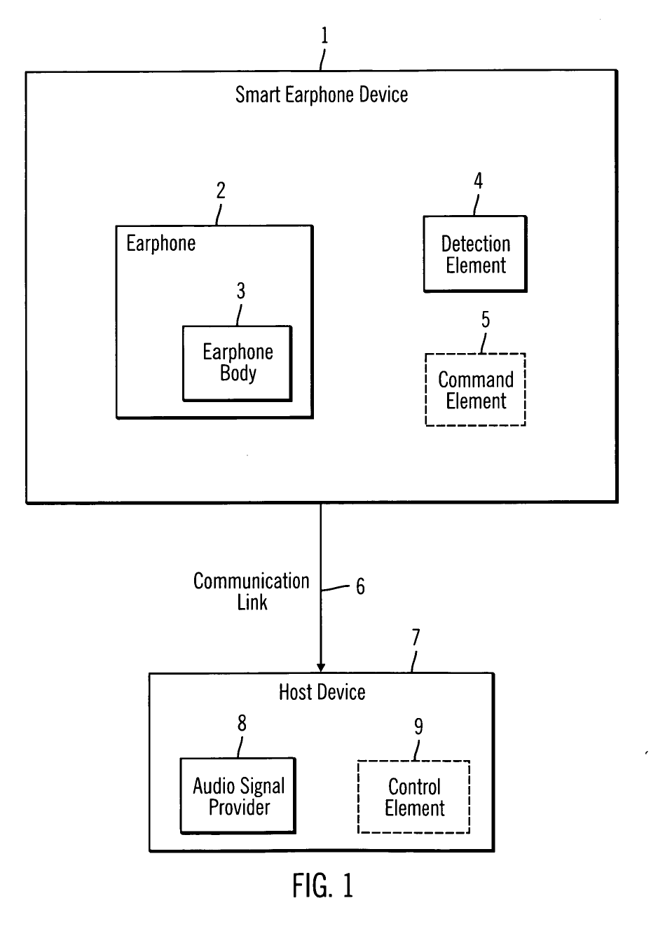

FIG. 1 shows a block diagram of a system having a smart earphone device 1 in communication with a host device 7 through a communication link 6, in accordance with an embodiment of the invention. The smart earphone device 1 comprises an earphone 2 and a detection element 4. The smart earphone device 1 may further comprise a command element 5. The host device 7 comprises an audio signal provider 8. The host device 7 may further comprise a control element 9.

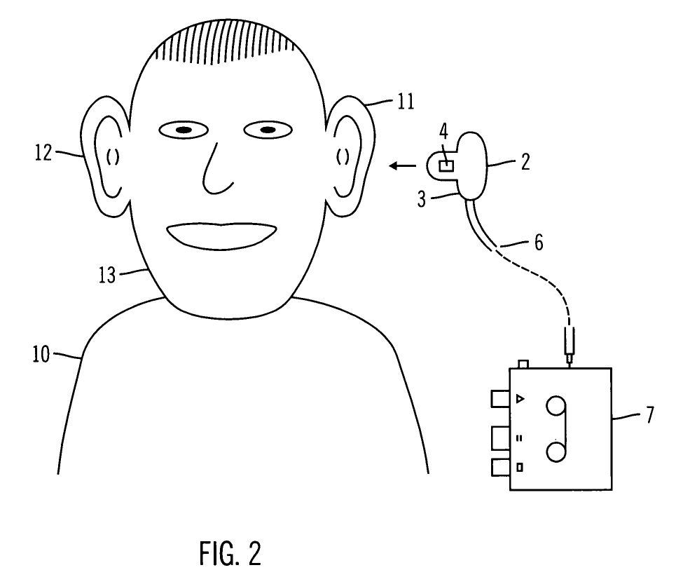

The earphone 2 of the smart earphone device 1 comprises an earphone body 3 and is capable of converting audio signals provided by the audio signal provider 8 into audible sound. As illustrated in FIG. 2, a user 10 positions the earphone 2 in a listening position near an ear 11 or 12 in order to listen to audible sound provided by the earphone 2. The listening position varies based on the type of earphone 2 that is used in the smart earphone device 1. In the following discussion, listening positions will be described with reference to the ear 11, but the same description also applies to the ear 12.

In one example embodiment, the earphone 2 is of a type that has an earphone body 3 that can be fit into the ear 11 of the user 10. In such an embodiment, the user 10 positions the earphone 2 in a listening position by inserting the earphone body 3 into the ear 11. Examples of such a type of earphone 2 include, but are not limited to, an earbud, an earpiece, and the like.

In various other embodiments, the earphone 2 is of a type that has an earphone body 3 that can be held next to the ear 11 of the user 10. In such embodiments, the user 10 positions the earphone 2 in a listening position by placing the earphone body 3 next to the ear 11. Examples of such a type of earphone 2 include, but are not limited to, a headphone, a headset, and the like.

The detection element 4 of the smart earphone device 1 provides detection output from which it can be determined whether or not the earphone 2 is in a listening position. In a preferred embodiment, the detection element 4 is disposed on the earphone body 3, but the detection element could be located in other suitable locations that allow the detection element 4 to detect whether or not the earphone 2 is in a listening position. Various types of sensors or switches could be employed as the detection element 4 including, but not limited to, a temperature sensor, a pressure sensor, an electrical circuit, a capacitive touch plate, a light sensor, and the like.

The host device 7 is any type of device that is capable of providing audio signals. Examples of such a type of host device 7 include, but are not limited to, a radio, a cassette player, an MP3 player, a CD player, a DVD player, a portable telephone, a computer, a television, and the like. In many instances, the host device 7 comprises a housing that is separate from the earphone body 3. However, the host device 7 could be disposed on the earphone body 3 or embedded within the earphone body 3. An example of a host device 7 that can be embedded within the earphone body 3 is a hearing aid.

The host device 7 can be controlled to perform one or more operations. For example, the host device 7 may perform the operation of “turn on” to turn on the host device 7 and the operation of “turn off” to turn off the host device 7. If the host device 7 is of a type that provides audio signals from audio sound recordings or video recordings, such as an MP3 player or DVD player, the host device 7 may perform the operations of play, pause, stop, fast forward, rewind, volume up, volume down, mute, and the like. If the host device 7 is a type of telephone, the host device 7 may perform the operations of dial, hang up, provide dial tone, and the like. Other types of host devices may perform numerous other types of operations.

The detection output of the detection element 4 of the smart earphone device 1 is used to control one or more operations of the host device 7. In some embodiments, the detection output of the detection element 4 is sent directly to the host device 7 to control an operation of the host device 7. In various other embodiments, the smart earphone device 1 comprises a command element 5, and the detection output of the detection element 4 is sent to the command element 5. The command element 5 then generates a command to be issued to the host device 7 based on the detection output. Each command may specify one or more operations to be performed by the host device 7. It is also possible for the command element 5 to be located in the host device 7 rather than in the smart earphone device 1.

In addition to being controlled based on the detection output of the detection element 4 of the smart earphone device 1, a host device 7 employed with further embodiments may further allow for commands to be entered in other ways. For example, the host device 7 may have switches and buttons disposed on a housing of the host device 7 that are operable to cause the host device 7 to perform predefined operations. The host device 7 may further include an LCD screen or other display device for operations to be selected from a displayed menu.

In some embodiments, the audio signal provider 8 of the host device 7 is controlled directly by the detection output of the detection element 4 of the smart earphone device 1. In various other embodiments, the host device 7 may include the control element 9, in which case the audio signal provider 8 would be controlled by control signals sent from the control element 9. The control element 9 may be designed to accept commands from the command element 5 and to generate control signals to cause the host device 7 to carry out the operations specified by the commands. If there is no command element 5, the control element 9 may receive, directly, the detection output of the detection element 4 of the smart earphone device 1 and then generate control signals based on the detection output.

The smart earphone device 1 communicates with the host device 7 through a communication link 6. The host device 7 sends audio signals provided by the audio signal provider 8 to the smart earphone device 1 and the smart earphone device 1 sends detection output provided by the detection element 4 or commands provided by the command element 5 to the host device 7 through the communication link 6. In some embodiments, the communication link 6 comprises separate communication lines for transmitting the audio signals and for transmitting the detection output or commands. In various other embodiments, the audio signals and the detection output or commands are transmitted over a same communication line of the communication link 6. Transmitting the detection output or commands over the same communication line as the audio signals provides the advantage that, for earphones with an already existing communication line for audio, an additional communication line would not be required.

In a preferred embodiment, the communication link 6 comprises one or more electrically conductive wires attached to the earphone 2 of the smart earphone device 1 at one end and attached to a terminal plug at the other end, the terminal plug being inserted into a jack of the host device 7. In various other embodiments, the communication link 6 comprises a wireless transceiver disposed in the earphone body 3 and a corresponding wireless transceiver disposed in a housing of the host device 7. The wireless transceivers allow for wireless communication between the smart earphone device 1 and the host device 7 and may comprise, but are not limited to, optical transceivers, RF transceivers, microwave transceivers, and the like.

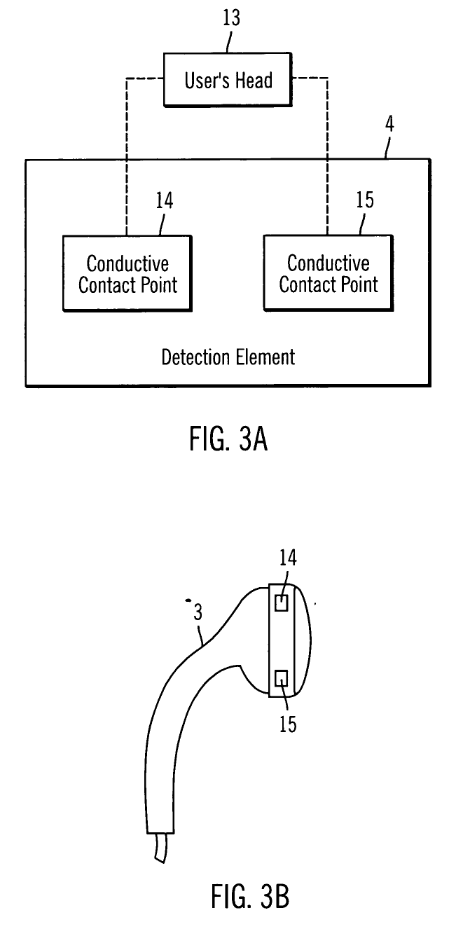

Various examples of sensors and switches that may be used for the detection element 4 of the smart earphone device 1 in accordance with various respective embodiments of the invention are described with reference to FIGS. 3-5.

FIG. 3A shows a block diagram of an example of the detection element 4 comprising electrodes or other conductive contact points 14 and 15. As shown in FIG. 3B, the conductive contact points 14 and 15 may be disposed on an outer surface of the earphone body 3. Conductive contact point 14 is connected to a power supply that can be located in any suitable location including, but not limited to, in the earphone body 3 or in the host device 7. Conductive contact point 15 should be electrically insulated from the earphone body 3 so that no current flows from conductive contact point 14 to conductive contact point 15 when the earphone 2 is not in a listening position (such as not fit into or held next to the ear 11 of the user 10).

When the earphone body 3 is placed into the ear 11 of the user 10, skin within the ear 11 comes into contact with the contact points 14 and 15. The head 13 of the user 10 conducts electricity from conductive contact point 14 to conductive contact point 15 and, thus, completes a circuit. The detection output of the detection element 4 reflects whether or not the earphone 2 is in a listening position by, for example, being a “high” signal when the circuit is completed and a “low” signal when the circuit is not completed. Using the user's body to complete a circuit is similar to that which is done for a heart pulse monitor in U.S. Pat. No. 4,319,581 entitled “Heart Pulse Monitoring Apparatus”, the contents of which are incorporated by reference herein.

It is possible for more than two conductive contact points to be disposed on the earphone body 3. Also, the conductive contact points 14, 15 can be disposed anywhere on the earphone body 3, including on the sides and the front (face) of the earphone body 3.

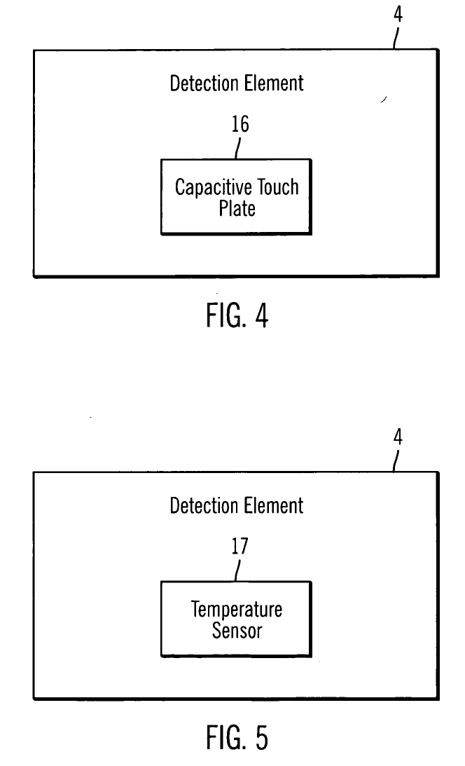

FIG. 4 shows a block diagram of an example of the detection element 4 comprising a capacitive touch plate 16. The use of capacitive touch plates to sense the proximity of an object is described in U.S. Pat. No. 6,466,036 entitled “Charge Transfer Capacitance Measurement Circuit”, the contents of which are incorporated by reference herein.

The capacitive touch plate 16 may be disposed on the earphone body 3 and can be used in conjunction with a sample capacitor as a type of proximity switch. A value of a capacitance of the capacitive touch plate 16 during operation may be determined by sampling the voltage across the sample capacitor connected to the capacitive touch plate 16. The value of the voltage across the sample capacitor may then be detection output reflecting whether or not the capacitive touch plate 16 is near the ear 11 of the user 10. If the communication link 6 includes an electrically conductive wire for transmitting audio signals, the electrically conductive wire could also be used for capacitive sensing to measure the capacitance of the capacitive touch plate 16. In various embodiments, the detection element 4 comprises two or more capacitive touch plates and one or more sample capacitors.

FIG. 5 shows a block diagram of an example of the detection element 4 comprising a temperature sensor 17. The temperature sensor 17 may be disposed on the earphone body 3 or may be embedded within the earphone body 3. The detection output of the temperature sensor 17 is a value of a sensed temperature and it could be determined from the sensed temperature whether or not the earphone 2 is in a listening position. In various embodiments, the temperature sensor output is sent to the command element 5 and the command element 5 comprises logic to determine whether or not the earphone 2 is in a listening position based on the temperature sensor output. The command element 5 may then send a related command to the host device 7.

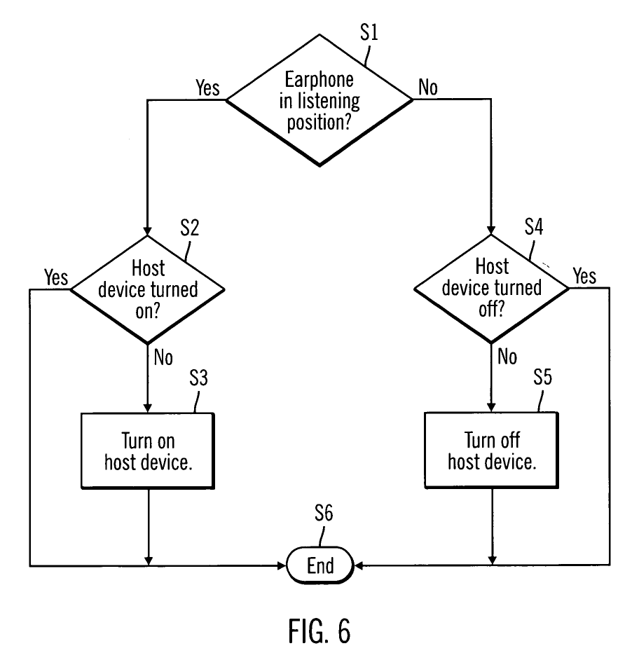

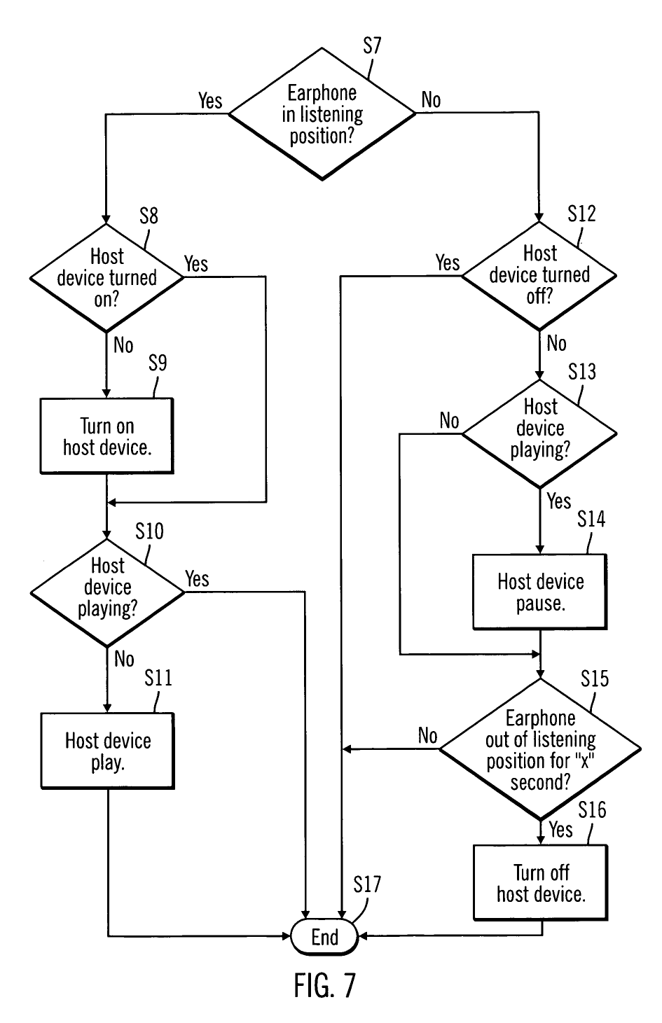

Example processes of the detection output of the detection element 4 of the smart earphone device 1 causing the host device 7 to control operations are described with reference to FIGS. 6-7.

FIG. 6 is a flowchart showing an example process of the detection output of the detection element 4 of the smart earphone device 1 causing operations to be performed by the host device 7.

In S1, it is determined based on the detection output whether or not the earphone 2 is in a listening position. This determination could be made by the host device 7 after receiving the detection output or could be made by the command element 5, if present, after receiving the detection output.

If it is determined in S1 that the earphone 2 is in the listening position, then it is determined in S2 whether or not the host device 7 is turned on. Again, this determination could be made by the host device 7 or by the command element 5, if present. If it is determined in S2 that the host device 7 is not turned on, then the host device 7 is turned on in S3 and the process ends. If it is determined in S2 that the host device 7 is turned on, then the process ends. If the determination in S2 is made by the command element 5, then the command element 5 would issue a command to the host device 7 in S3 to have the host device 7 turn on.

If it is determined in S1 that the earphone 2 is not in the listening position, then it is determined in S4 whether or not the host device 7 is turned off. If it is determined in S4 that the host device 7 is not turned off, then the host device 7 is turned off in S5 and the process ends. If it is determined in S4 that the host device 7 is turned off, then the process ends.

In some embodiments, the process of FIG. 6 may be performed continually or be set up to run at specified time intervals. In various other embodiments, the smart earphone device 1 may be configured to detect when there is a change in the listening position of the earphone 2 based on the detection output and then cause the process to be executed when a change is detected.

In accordance with the process shown in FIG. 6, the host device 7 can be transparently controlled to turn on when the earphone 2 is placed in a listening position and to turn off when the earphone 2 is removed from the listening position. Thus, the user is not required to issue an additional command to the host device 7 to turn on once the earphone 2 is in the listening position. Also, the user does not need to remember to issue an additional command to turn off the host device 7, because the host device 7 is automatically turned off when the earphone 2 is removed from the listening position. Thus, there is added convenience to the user and there is also the potential to conserve battery life by turning off the host device 7 when no one is listening.

FIG. 7 is a flowchart showing another example process of the detection output of the detection element 4 of the smart earphone device 1 causing the host device 7 to control operations.

In S7 it is determined from the detection output whether or not the earphone 2 is in a listening position. If it is determined in S7 that the earphone 2 is in the listening position, then in S8 it is determined whether or not the host device 7 is turned on. If it is determined in S8 that the host device 7 is not turned on, then the host device 7 is turned on in S9 and the process continues to S10. If it is determined in S8 that the host device 7 is turned on, then the process continues to S10. In S10, it is determined whether or not the host device 7 is playing. If it is determined in S10 that the host device 7 is not playing, then the host device 7 is caused to play in S11 and the process ends. If it is determined in S10 that the host device 7 is playing, then the process ends.

On the other hand, if it is determined in S7 that the earphone 2 is not in the listening position, then in S12 it is determined whether or not the host device 7 is turned off. If it is determined in S12 that the host device 7 is turned off, then the process ends. If it is determined in S12 that the host device 7 is not turned off, then in S13 it is determined whether or not the host device 7 is playing. If it is determined in S13 that the host device 7 is playing, then the host device 7 is caused to pause in S14 and the process continues to S15. If it is determined in S13 that the host device 7 is not playing, then the process continues to S15.

In S15 it is determined whether or not the earphone 2 has been out of the listening position for more than “x” seconds, where “x” is a preset value. A counter could be used to count the amount of time the earphone 2 is out of the listening position and the counter output could be compared with the value “x”. If it is determined in S15 that the earphone 2 has been out of the listening position for more than “x” seconds, then the host device 7 is turned off in S16 and the process ends. If it is determined in S15 that the earphone 2 has not been out of the listening position for more than “x” seconds, then the process ends.

In accordance with the process shown in FIG. 7, a type of host device 7 that plays stored audio content, such as an MP3 player, could transparently turn on and start playing the audio content when the earphone 2 is placed in a listening position. Also, the host device 7 could be paused when the earphone 2 is removed from the listening position, and if the earphone 2 remains removed from the listening position for more than “x” seconds, then the host device 7 could be automatically turned off. Such a process may act to smooth out the experience of a user by playing audio signals from a host device when an earphone is in a listening position and pausing the host device when the earphone is out of the listening position. Thus, the user would not miss any of the audio content when the earphone is removed from the listening position. Also, by automatically turning off the host device 7 when the earphone 2 is removed from the listening position for more than “x” seconds, there is the potential to conserve battery life.

While the processes represented in FIGS. 6 and 7 are example embodiments of processes for causing operations to be performed by the host device 7 based on the detection output of the detection element 4 of the smart earphone device 1, other processes which involve different operations to be performed based on different positions of the earphone 2 and different types of the host device 7, are within the scope of further embodiments. For example, if the host device 7 is a portable telephone, the host device 7 could be caused to perform the operation of “provide dial tone” rather than “play” and the operation of “hang up” rather than “pause”.

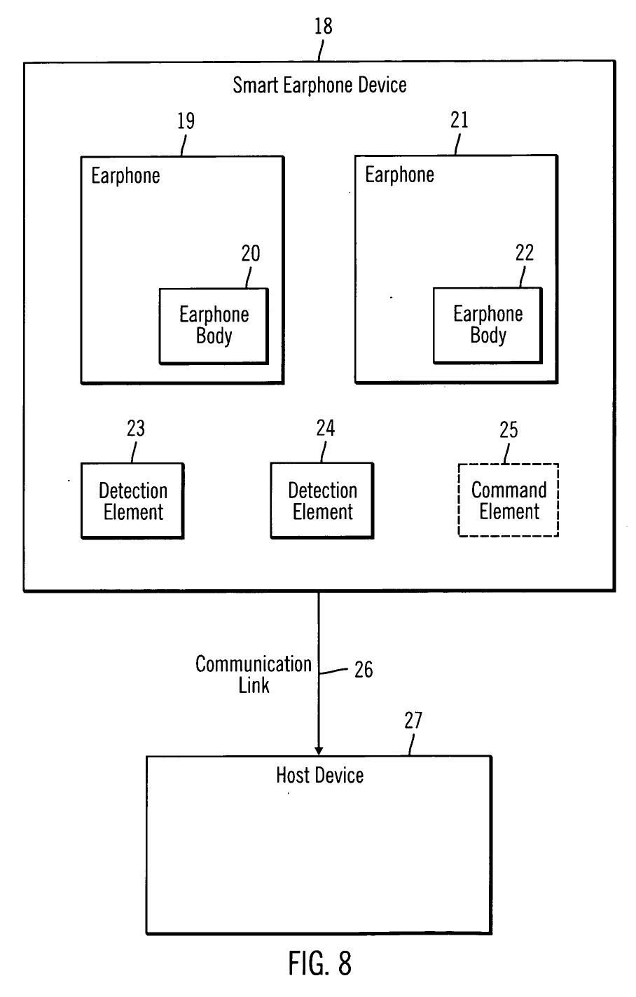

FIG. 8 shows a block diagram of a smart earphone device 18 of another preferred embodiment in communication with a host device 27 through a communication link 26. The smart earphone device 18 comprises a first earphone 19, a second earphone 21, a first detection element 23, and a second detection element 24. The first earphone 19 comprises a first earphone body 20 and the second earphone 21 comprises a second earphone body 22. In various embodiments, the smart earphone device 18 further comprises a command element 25.

The smart earphone device 18 differs from the smart earphone device 1 in that the smart earphone device 18 comprises two earphones and two detection elements. The first detection element 23 detects whether or not the first earphone 19 is in a listening position. The second detection element 24 detects whether or not the second earphone 21 is in a listening position. The two earphones may have different listening positions. In normal use, the first earphone body 20 is fit into or held next to a first ear 11 of the user 10 and the second earphone body 22 is fit into or held next to a second ear 12 of the user 10.

By adding the second earphone 21 and the second detection element 24 to the smart earphone device 18, there is an opportunity to provide added functionality. For example, different operations could be performed depending on whether (a) both earphones 19, 21 are in listening positions; (b) the first earphone 19 is in a listening position and the second earphone 21 is not in a listening position; (c) the second earphone 21 is in a listening position and the first earphone 19 is not in a listening position; or (d) both earphones 19, 21 are not in listening positions.

In various embodiments, the detection elements 23, 24 comprise capacitive touch plates connected to a sample capacitor. The capacitive touch plates could be disposed on or embedded in the earphone bodies 20, 22. In such an embodiment, the communication link 26 may comprise a right, a left, and a common speaker wire connected to the earphone 2. The communication link 26 may also comprise a jack plug with a 3 conductor design where capacitive sensing is used on the right, left, and common speaker wires. In various other embodiments, the detection elements 23, 24 may comprise sensors, switches, electrical circuits, and the like.

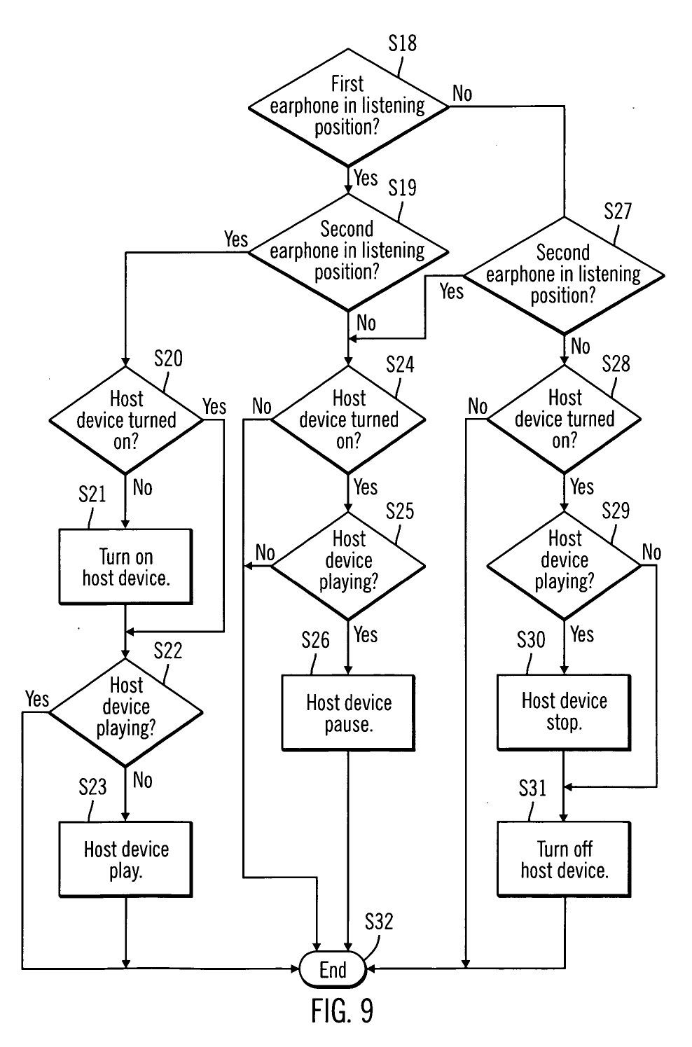

FIG. 9 is a flowchart showing an example process of the first detection output of the first detection element 23 and the second detection output of the second detection element 24 of the smart earphone device 18 causing the host device 27 to control various operations.

In S18 it is determined from the first detection output whether or not the first earphone 19 is in a first listening position. If it is determined in S18 that the first earphone 19 is in the first listening position, then in S19 it is determined from the second detection output whether or not the second earphone 21 is in a second listening position. If it is determined in S19 that the second earphone 21 is in the second listening position, then it is determined in S20 whether or not the host device 27 is turned on.

If it is determined in S20 that the host device 27 is not turned on, then in S21 the host device 27 is turned on and the processing continues to S22. If it is determined in S20 that the host device 27 is turned on, then the processing continues to S22. In S22, it is determined whether or not the host device 27 is playing. If it is determined in S22 that the host device 27 is playing, then the process ends. If it is determined in S22 that the host device 27 is not playing, then the host device 27 is caused to start playing in S23 and the process ends.

If it is determined in S19 that the second earphone 21 is not in the second listening position, then it is determined in S24 whether or not the host device 27 is turned on. If it is determined in S24 that the host device 27 is not turned on, then the process ends. If it is determined in S24 that the host device 27 is turned on, then it is determined in S25 whether or not the host device 27 is playing. If it is determined in S25 that the host device 27 is not playing, then the process ends. If it is determined in S25 that the host device 27 is playing, then the host device is caused to pause in S26 and the process ends.

If it is determined in S18 that the first earphone 19 is not in the first listening position, then it is determined in S27 whether or not the second earphone 21 is in the second listening position. If it is determined that the second earphone 21 is in the second listening position, then the process continues to S24 and proceeds as described above.

If it is determined in S27 that the second earphone 21 is not in the second listening position, then it is determined in S28 whether or not the host device 27 is turned on. If it is determined in S28 that the host device 27 is not turned on, then the process ends. If it is determined in S28 that the host device 27 is turned on, then it is determined in S29 whether or not the host device 27 is playing.

If it is determined in S29 that the host device 27 is playing, then the host device 27 is caused to stop playing in S30, the host device 27 is turned off in S31, and the process ends. If it is determined in S29 that the host device 27 is not playing, then the host device 27 is turned off in S31 and the process ends.

In accordance with the example process shown in FIG. 9, a type of host device 27 that plays stored audio content, such as a CD player, could transparently turn on and start playing audio content when both earphones 19, 21 are placed in listening positions. Also, the host device 27 could be paused when one of the earphones 19, 21 is removed from a listening position. Furthermore, the host device 27 could be caused to stop playing and to turn off when both earphones 19, 21 are removed from listening positions.

Such a process may act to smooth out the experience of a user by automatically playing audio signals from a host device when both earphones are in listening positions, pausing the host device when one of the earphones is removed, and stopping or turning off the host device when both earphones are removed from listening positions. The process could be useful, for example, to a user who is listening to audio content through two earphones while waiting to board a flight in an airport and needs to hear an announcement made over a loudspeaker in the airport. The user could remove one of the earphones, causing the audio to pause, and listen to the announcement. Then, once the announcement has completed, the user could reinsert the earphone and the host device would automatically resume playing.

A similar process may allow for a smart earphone device to cause a host device to switch between a mono mode and a stereo mode depending on whether one or two earphones are in listening positions. If one earphone is placed in a listening position, then the host device would switch to a mono mode, while if two earphones are placed in listening positions, the host device would be caused control an operation to switch to a stereo mode.

Further embodiments of a smart earphone device may include more than two earphones and more than two detection elements. Some embodiments may comprise a band made of plastic or wire that can be fit over the head of a user and that can support one or more earphones. A detection element could then be disposed on the band. Various other embodiments of the smart earphone device may be powered by a power supply located in a host device while other embodiments of the smart earphone device may comprise an independent power supply.

While the above embodiments include a detection element for providing detection output from which is can be determined whether or not an earphone is in a listening position, an alternative embodiment may include a detection element for providing detection output from which it can be determined whether or not a user is touching or pressing on an earphone. For example, a detection element may be placed on a backside of an earphone, and the detection element may provide detection output from which it can be determined whether or not a user is touching the earphone with a finger. Such a configuration would allow for the user to just touch the earphone with a hand or finger as it sits in (or around) an ear in order to control a host device. The detection element used in such a configuration may include, but is not limited to, a pressure sensor, a switch, a conductive contact point, and the like.

The embodiments disclosed herein are to be considered in all respects as illustrative, and not restrictive of the invention. The present invention is in no way limited to the embodiments described above. Various modifications and changes may be made to the embodiments without departing from the spirit and scope of the invention. The scope of the invention is indicated by the attached claims, rather than the embodiments. Various modifications and changes that come within the meaning and range of equivalency of the claims are intended to be within the scope of the invention.

What is claimed is:

1. A smart earphone device for use with a host device, the smart earphone device comprising:
an earphone for converting sound signals provided by the host device into audible sound; and
a detection element for providing detection output from which it can be determined whether or not the earphone is in a listening position;
wherein the detection output can be used to cause the host device to control an operation.

2. The smart earphone device of claim 1, wherein the earphone comprises an earphone body.

3. The smart earphone device of claim 2, wherein the detection element is disposed on the earphone body or is embedded in the earphone body.

4. The smart earphone device of claim 2, wherein the earphone is in the listening position when the earphone body is fit into an ear of a user.

5. The smart earphone device of claim 2, wherein the earphone is in the listening position when the earphone body is held next to an ear of a user.

6. The smart earphone device of claim 1, wherein the earphone comprises at least one of an earbud, an earpiece, and a headphone.

7. The smart earphone device of claim 1, wherein the detection output is a signal for causing the host device to control one or more operations including at least one of turn on, play, fast forward, rewind, volume up, volume down, resume, answer call, un-mute, change track, change station, change channel, dial, provide dial tone, and beep when the earphone is placed in the listening position.

8. The smart earphone device of claim 1, wherein the detection output is a signal for causing the host device to control one or more operations including at least one of turn off, pause, stop, end call, mute, and beep when the earphone is removed from the listening position.

9. The smart earphone device of claim 1, wherein the detection output is used to cause the host device to perform two or more operations.

10. The smart earphone device of claim 1,
wherein the detection output is used to cause the host device to play a stored sound recording when the earphone is in the listening position; and
wherein the detection output is used to cause the host device to pause the playing of the stored sound recording when the earphone is out of the listening position.

11. The smart earphone device of claim 1,
wherein the detection output is used to cause the host device to provide a dial tone when the earphone is placed in the listening position; and
wherein the detection output is used to cause the host device to hang up when the earphone is removed from the listening position.

12. The smart earphone device of claim 1, wherein the detection output is used to cause the host device to turn on and to play a stored sound recording when the earphone is placed in the listening position.

13. The smart earphone device of claim 1, wherein the detection output is used to cause the host device to turn off when the earphone has been out of the listening position for longer than a specified time period.

14. The smart earphone device of claim 1, further comprising a second earphone for converting sound signals provided by the host device into audible sound.

15. The smart earphone device of claim 14, further comprising a second detection element for providing second detection output from which it can be determined whether or not the second earphone is in a second listening position;
wherein when the earphone is in the listening position and the second earphone is in the second listening position, the host device is caused to perform a first operation;
wherein when the earphone is in the listening position and the second earphone is not in the second listening position, the host device is caused to perform a second operation; and
wherein when the earphone is not in the listening position and the second earphone is not in the second listening position, the host device is caused to perform a third operation.

16. The smart earphone device of claim 1, wherein the detection element comprises a sensor.

17. The smart earphone device of claim 16, wherein the sensor comprises at least one of a pressure sensor, a temperature sensor, a light sensor, and an audio sensor.

18. The smart earphone device of claim 1, wherein the detection element comprises a capacitive touch plate.

19. The smart earphone device of claim 1,
wherein the detection element comprises a first conductive contact point and a second conductive contact point; and
wherein an electrical circuit is completed from the first conductive contact point to the second conductive contact point through a head of a user when the earphone is in the listening position.

20. The smart earphone device of claim 1, wherein the detection element comprises a switch.

21. The smart earphone device of claim 1, further comprising a command element for providing a command to be issued to the host device based on the detection output.

22. The smart earphone device of claim 1, further comprising a communication link for receiving audio signals from the host device and for sending detection output to the host device.

23. The smart earphone device of claim 22,
wherein the communication link comprises an electrically conductive wire having two ends;
wherein one end of the wire is connected to the earphone;
wherein the other end of the wire is connected to a terminal plug; and
wherein the terminal plug can be inserted into a jack of the host device.

24. The smart earphone device of claim 22, wherein the communication link comprises a wireless transceiver.

25. The smart earphone device of claim 1, further comprising:
a command element for providing a command to be issued to the host device based on the detection output; and
a communication link for receiving audio signals from the host device and for sending commands from the command element to the host device.

26. The smart earphone device of claim 1,
wherein the detection output is used to cause the host device to perform a first operation when the earphone is placed in the listening position; and
wherein the detection output is used to cause the host device to perform a second operation when the earphone is removed from the listening position.

27. A method for causing an operation to be performed by a host device, the method comprising:
providing an earphone for converting sound signals from the host device into audible sound;
detecting whether or not the earphone is in a listening position; and
causing an operation to be performed by the host device based on whether or not the earphone is in the listening position.

28. The method of claim 27, wherein the step of causing an operation to be performed by the host device based on whether or not the earphone is in the listening position, comprises:
causing an operation to be performed by the host device when the earphone is placed in the listening position.

29. The method of claim 27, wherein the step of causing an operation to be performed by the host device based on whether or not the earphone is in the listening position, comprises:
causing an operation to be performed by the host device when the earphone is removed from the listening position.

30. The method of claim 27, wherein the step of causing an operation to be performed by the host device based on whether or not the earphone is in the listening position, comprises:
causing a first operation to be performed by the host device when the earphone is placed in the listening position; and
causing a second operation to be performed by the host device when the earphone is removed from the listening position.

31. The method of claim 27, wherein the step of causing an operation to be performed by the host device based on whether or not the earphone is in the listening position, comprises:
causing the host device to turn on when the earphone is placed in the listening position; and
causing the host device to turn off when the earphone is removed from the listening position.

32. The method of claim 27, wherein the step of causing an operation to be performed by the host device based on whether or not the earphone is in the listening position, comprises:
causing the host device to play a stored sound recording when the earphone is placed in the listening position; and
causing the host device to pause the playing of the stored sound recording when the earphone is removed from the listening position.

33. The method of claim 27, wherein the step of causing an operation to be performed by the host device based on whether or not the earphone is in the listening position, comprises:
causing an operation to be performed by the host device when the earphone has been removed from the listening position for longer than a specified time period.

34. The method of claim 27, further comprising the steps of:
providing a second earphone for converting sound signals from the host device into audible sound; and
detecting whether or not the second earphone is in a second listening position;
wherein the step of causing an operation to be performed by the host device based on whether or not the earphone is in the listening position, comprises:
causing a first operation to be performed by the host device when the earphone is in the listening position and the second earphone is in the second listening position;
causing a second operation to be performed by the host device when the earphone is in the listening position and the second earphone is not in the second listening position; and
causing a third operation to be performed by the host device when the earphone is not in the listening position and the second earphone is not in the second listening position.

35. The method of claim 27, wherein the step of detecting whether or not the earphone is in a listening position, comprises:
providing a sensor on the earphone; and
determining from the sensor output whether or not the earphone is in a listening position.

36. The method of claim 27, wherein the step of detecting whether or not the earphone is in a listening position, comprises:
providing a first conductive contact and a second conductive contact on the earphone; and
determining that the earphone is in a listening position when an electrical circuit is completed from the first conductive contact to the second conductive contact through a head of a user; and
determining that the earphone is not in the listening position when the electrical circuit is not completed.

37. A system for providing audible sound, comprising:
a host device for providing sound signals; and
a smart earphone device comprising:
an earphone for converting the sound signals provided by the host device into audible sound; and
a detection element for providing detection output from which it can be determined whether or not the earphone is in a listening position;
wherein the detection output can be used to cause the host device to control an operation.

38. The system of claim 37, wherein the host device comprises at least one of an MP3 player, a telephone, a computer, a radio, a cassette player, a CD player, a DVD player, a television, and a hearing aid.

39. The system of claim 37, wherein the host device comprises a control element that is responsive to the detection output for controlling the operation.

40. The system of claim 39, wherein the control element comprises at least one of electronic circuitry and software.

41. The system of claim 37, wherein the operation that is controlled by the host device is at least one of turn on, turn off, play, pause, stop, fast forward, rewind, volume up, volume down, mute, change track, change station, change channel, dial, hang up, provide dial tone, answer call, and beep.

42. The system of claim 37, wherein the detection output is a signal for causing the host device to perform two or more operations.

43. A smart earphone device for use with a host device, the smart earphone device comprising:
an earphone for converting sound signals provided by the host device into audible sound; and
a detection element for providing detection output from which it can be determined whether or not a user is touching the earphone;
wherein the detection output can be used to cause the host device to control an operation.

44. The smart earphone device of claim 43, wherein the earphone comprises an earphone body.

45. The smart earphone device of claim 44, wherein the detection element is disposed on a backside of the earphone body that faces away from an ear when the earphone is in a listening position.

46. The smart earphone device of claim 43, further comprising:
a second detection element for providing second detection output from which it can be determined whether or not the earphone is in a listening position; and
wherein the second detection output can be used to cause the host device to control an operation.

47. The smart earphone device of claim 46, wherein the detection output and the second detection output are used to cause the host device to perform a first operation when the earphone is placed in the listening position and is touched by a finger of the user.

48. The smart earphone device of claim 46, wherein the detection output and the second detection output are used to cause the host device to perform any number of operations including turn on, turn off, play, pause, stop, answer call, end call, mute, un-mute, resume, change channel, volume up, volume down, and beep when the earphone is placed in the listening position and is touched by a finger of the user.
